(19) United States
(12) Patent Application Publication
(10) Pub. No.: US 2020/0208721 A1
(43) Pub. Date: Jul. 2, 2020

(54) Automatic retracting and retracting device for a traffic cone

(71) Applicant: Jiangnan Liu, Qingdao City (CN)

(72) Inventor: Jiangnan Liu, Qingdao City (CN)

(21) Appl. No.: 16/816,295

(22) Filed: Mar. 12, 2020

(30) Foreign Application Priority Data
Dec. 10, 2019 (CN) 2019112610078

(51) Int. Cl. F16H 29/00; F16H 1/20; F16H 1/22; E01F 9/70

(52) U.S. Cl. CPC F16H 29/00; E01F 9/70; F16H 1/222; F16H 1/203

(57) ABSTRACT

The invention discloses an automatic retracting and retracting device for a traffic cone, which includes a base body and a fixed plate. The base body is provided with a first movable cavity, the first movable cavity is provided with an intermittent pushing mechanism, and the first movable cavity is above the first movable cavity. A rotation cavity is provided, and a reciprocating rotation mechanism is provided in the rotation cavity. A second movable cavity with a rightward opening is provided above the rotation cavity. A retractable mechanism is provided in the second movable cavity. The rotation cavity is left. A first rectangular slot is provided on the side, a second rectangular slot is provided below the first rectangular slot, a transmission mechanism is provided in the second rectangular slot, a lower end wall of the first rectangular slot and an upper end of the second rectangular slot A first rotating shaft is rotatably installed between the walls, an upper end of the first rotating shaft extends into the first rectangular groove and a first bevel gear is fixedly installed, and a lower end of the first rotating shaft extends into the second rectangular groove. A middle bevel gear is fixedly installed in the middle.

### CROSS-REFERENCES TO RELATED APPLICATIONS

The present application claims priority from Chinese application No. 2019112610078 filed on Sep. 19, 2019 which is hereby incorporated by reference in its entirety.

### TECHNICAL FIELD

The invention relates to the technical field of intelligent transportation, and in particular relates to an automatic retracting and retracting device for a traffic cone.

### BACKGROUND OF THE INVENTION

Traffic cones play a very important role in road traffic. They are a road traffic isolation and warning facility that tells passing vehicles that there are obstacles in front of them, or that they have to change lanes or work ahead. At present, the maintenance of traffic roads in China mainly relies on manual collection and release of traffic cones. This operation method is not only slow, time-consuming and labor-intensive, but also has a very low safety factor. Especially for some expressways or highways, because the speeds of the vehicles in the past are relatively fast, the danger is particularly prominent, and accidents are likely to occur again, resulting in personal injury.

### BRIEF SUMMARY OF THE INVENTION

In view of the shortcomings of the above technologies, the present invention proposes an automatic traffic cone retracting and retracting device, which can overcome the above defects.

An automatic retracting and retracting device for a traffic cone according to the present invention includes a base body and a fixed plate. The base body is provided with a first movable cavity, the first movable cavity is provided with an intermittent pushing mechanism, and the upper part of the first movable cavity is provided with There is a rotating cavity, a reciprocating rotating mechanism is provided in the rotating cavity, a second movable cavity opening to the right is provided above the rotating cavity, a retracting mechanism is provided in the second movable cavity, and the left side of the rotating cavity A first rectangular slot is provided, a second rectangular slot is provided below the first rectangular slot, a transmission mechanism is provided in the second rectangular slot, a lower end wall of the first rectangular slot and an upper end wall of the second rectangular slot A first rotating shaft is installed between the first rotating shaft, the upper end of the first rotating shaft is inserted into the first rectangular groove and a first bevel gear is fixedly installed, and the lower end of the first rotating shaft is inserted into the second rectangular groove. A second bevel gear is fixedly installed, a third rectangular slot is provided above the second rectangular slot, a driving mechanism is provided in the third rectangular slot, and a fourth rectangular slot is provided on the right side of the second rectangular slot. A fifth rectangular slot is provided on the right side of the fourth rectangular slot, and the second A second rotating shaft penetrating through the fourth rectangular groove is provided between the right end wall of the shaped groove and the left end wall of the fifth rectangular groove, and the right end of the second rotating shaft extends into the fifth rectangular groove and is fixedly installed. A third bevel gear, a fourth bevel gear fixedly connected to the second rotating shaft is provided in the fourth rectangular groove, an intermittent rotation mechanism is provided above the fixed plate, and a feeding mechanism is provided at the upper end wall of the base body.

Preferably, the intermittent pushing mechanism includes a third rotating shaft and a fourth rotating shaft which are installed in the rear wall of the first movable cavity symmetrically, and the front end of the third rotating shaft extends into the first movable cavity and A first rotating plate is rotatably installed, a second fixed shaft is fixedly installed in the second rotating plate, and a front end of the fourth rotating shaft extends into the first movable cavity and a second rotating plate is rotatably installed. A first fixed shaft is fixedly installed in the second rotating plate, and a third fixed shaft is fixedly installed symmetrically above and below the second rotating plate. A space between the lower end wall of the second movable cavity and the upper end wall of the first movable cavity is provided. There is a through hole, a fifth shaft is installed in the through hole, the lower end of the fifth shaft is inserted into the first movable cavity and a push block is fixedly installed, and the first and left symmetrically fixed first Four fixed shafts, a first connecting rod fixedly connected to the third fixed shaft are rotatably mounted on the fourth fixed shaft, and baffles are fixedly installed in the front and rear walls of the first movable cavity. A first spring is fixedly connected between the first rotating plate, and the baffle plate and the A second spring is fixedly connected between the second rotating plates. A sixth rotating shaft and a seventh rotating shaft are symmetrically installed in the rear wall of the first movable cavity, and the front end of the sixth rotating shaft extends into the first activity. A fifth bevel gear is fixedly installed in the cavity, a first cam is fixedly installed in the first movable cavity on the sixth rotating shaft, a fifth fixed shaft is fixedly installed on the first cam, and the fifth The fixed shaft is fixedly connected to the second fixed shaft through a first fixed-distance pull wire. The front end of the seventh rotation shaft extends into the first movable cavity and a sixth bevel gear is fixedly installed on the seventh rotation shaft. A second cam is fixedly installed in the first movable cavity, and a sixth fixed shaft is fixedly installed on the second cam, and the sixth fixed shaft and the first fixed shaft are fixedly connected through a second fixed-distance cable.

Preferably, the reciprocating rotation mechanism includes an eighth rotating shaft rotatably installed between the right end wall of the first rectangular groove and the left end wall of the rotating cavity, and the left end of the eighth rotating shaft projects into the first rectangular groove. A seventh bevel gear meshing with the first bevel gear is fixedly installed, and the right end of the eighth rotating shaft projects into the rotating cavity and is fixedly installed with a connecting plate, and a second connecting plate is fixedly installed in the connecting plate. A driving plate is movably installed on the second link, a rack is fixedly installed at the right end wall of the driving plate, and the fifth rotating shaft is fixedly installed in the rotating cavity to mesh with the rack First gear.

Preferably, the retracting mechanism includes a third link fixedly mounted on the upper end of the fifth rotating shaft, and the right end of the third link extends out of the base body and is fixedly mounted with an electromagnet.

Preferably, the transmission mechanism includes a ninth rotating shaft rotatably installed between the lower end wall of the first movable cavity and the upper end wall of the second rectangular groove, and the upper end of the ninth rotating shaft projects into the first movable cavity. An eighth bevel gear meshing with the fifth bevel gear is fixedly installed, the lower end of the ninth rotating shaft projects into the second rectangular groove and the ninth bevel gear is fixedly installed, and the left end of the second rotating shaft is fixedly installed. A power connection with a motor fixedly installed in the base body, a tenth bevel gear fixedly connected to the second rotating shaft and meshing with the second bevel gear is provided in the second rectangular groove, and the second An eleventh bevel gear fixedly connected to the second rotating shaft and meshing with the ninth bevel gear is provided in the rectangular groove.

Preferably, the driving mechanism includes a tenth rotation shaft rotatably installed between the lower end wall of the first movable cavity and the upper end wall of the third rectangular groove, and the upper end of the tenth rotation shaft extends into the first movable cavity. A twelfth bevel gear that meshes with the sixth bevel gear is fixedly installed, the lower end of the tenth rotation shaft projects into the third rectangular groove and a second pulley is fixedly installed, and the ninth rotation shaft A first pulley is fixedly installed in the third rectangular groove, and the first pulley and the second pulley are dynamically connected through a first belt.

Preferably, the intermittent rotation mechanism includes a tenth rotation shaft rotatably installed between the upper end wall of the fourth rectangular groove and the upper end wall of the base body, and the lower end of the tenth rotation shaft projects into the fourth rectangular groove and A twelfth bevel gear meshing with the fourth bevel gear is fixedly installed, an upper end of the tenth rotating shaft protrudes from the fixing plate and a rotating wheel is fixedly installed, and a first fixing rod is fixedly installed on the rotating wheel, A seventh fixed shaft is fixedly installed in the fixed plate, and a turntable which is in contact with the arcuate segment of the runner and is provided with a fixed distance groove is rotatably mounted on the upper end of the seventh fixed shaft. Two fixing rods, a bottom plate is fixedly mounted on the upper end of the second fixing rod, a positioning groove is provided on the upper end surface of the bottom plate, a traffic cone is positioned and installed on the bottom plate through the positioning groove, and a small cone is fixedly installed on the upper end of the traffic cone Iron blocks.

Preferably, the feeding mechanism includes an eleventh rotating shaft rotatably installed between the upper end wall of the fifth rectangular groove and the upper end wall of the base body, and the lower end of the eleventh rotating shaft projects into the fifth rectangular groove. A thirteenth bevel gear that meshes with the third bevel gear is fixedly mounted, an upper end of the eleventh rotation shaft protrudes from the base body and a push rod is fixedly installed, and a eleventh rotation shaft is fixedly installed. A three-belt wheel, a guide plate is fixedly installed at the outer end wall of the bottom plate, a roller is fixedly installed in front of the guide plate, a conveyor belt is fixedly installed on the roller, and a thirteenth rotating shaft is fixedly installed in the roller. A fourteenth bevel gear is fixedly installed at the right end of the thirteenth rotating shaft, and a twelfth rotating shaft is rotatably installed in the base body. The meshed fourth pulley is power-connected to the third pulley through a second belt.

The beneficial effect is that: when using, controlling the on/off of the electromagnet to generate magnetic presence to realize the placement and recovery of the traffic cone, the placement and recovery process is relatively stable, and accurate positioning can be guaranteed, thereby The accuracy of retracting and retracting the traffic cone is improved.

When in use, the motor can drive the push rod to rotate through the eleventh rotating shaft, and the push rod can push the traffic cone into the positioning groove, thereby intermittently supplementing the traffic cone, which can meet the needs The requirements for placing different quantities expand the range of use of the device.

### BRIEF DESCRIPTION OF THE DRAWINGS

In order to more clearly explain the embodiments of the invention or the technical solutions in the prior art, the drawings used in the description of the embodiments or the prior art are briefly introduced below. Obviously, the drawings in the following description are merely For some embodiments of the invention, for those of ordinary skill in the art, other drawings can be obtained based on these drawings without paying creative labor.

FIG. 1 is a schematic structural diagram of an embodiment of the present invention;

FIG. 2 is a schematic diagram at A-A in FIG. 1 according to an embodiment of the present invention; FIG.

FIG. 3 is a schematic diagram at B-B in FIG. 1 according to an embodiment of the present invention;

FIG. 4 is an enlarged schematic view of a structure at C in FIG. 1 according to an embodiment of the present invention;

FIG. 5 is an enlarged schematic view of the structure at D in FIG. 1 according to an embodiment of the present invention.

### DETAILED DESCRIPTION OF THE INVENTION

All features disclosed in this specification, or all disclosed methods or steps, except for mutually exclusive features and/or steps, may be combined in any way.

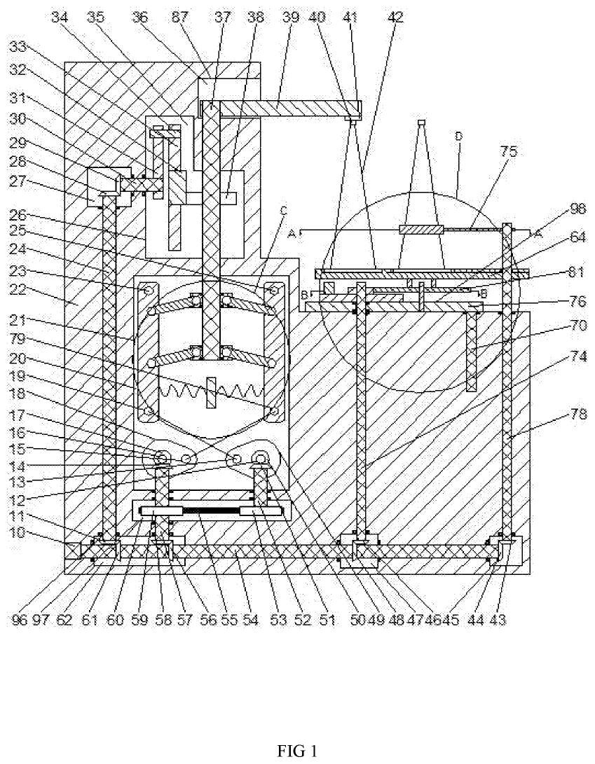

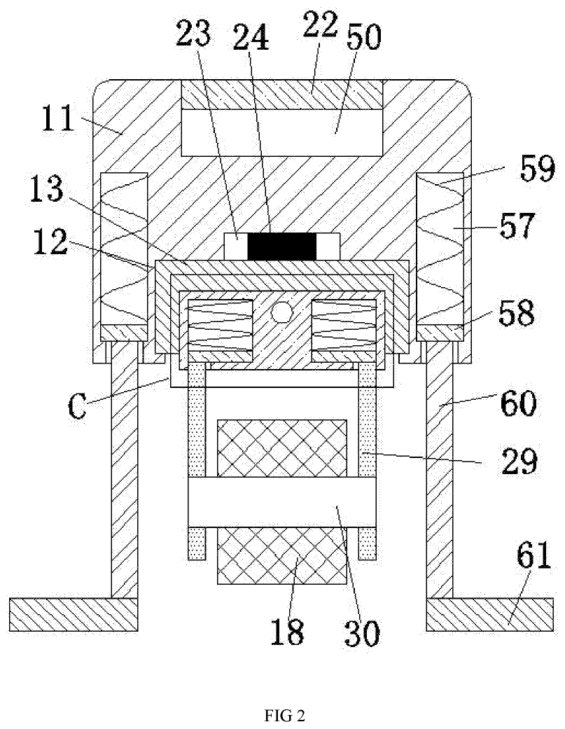

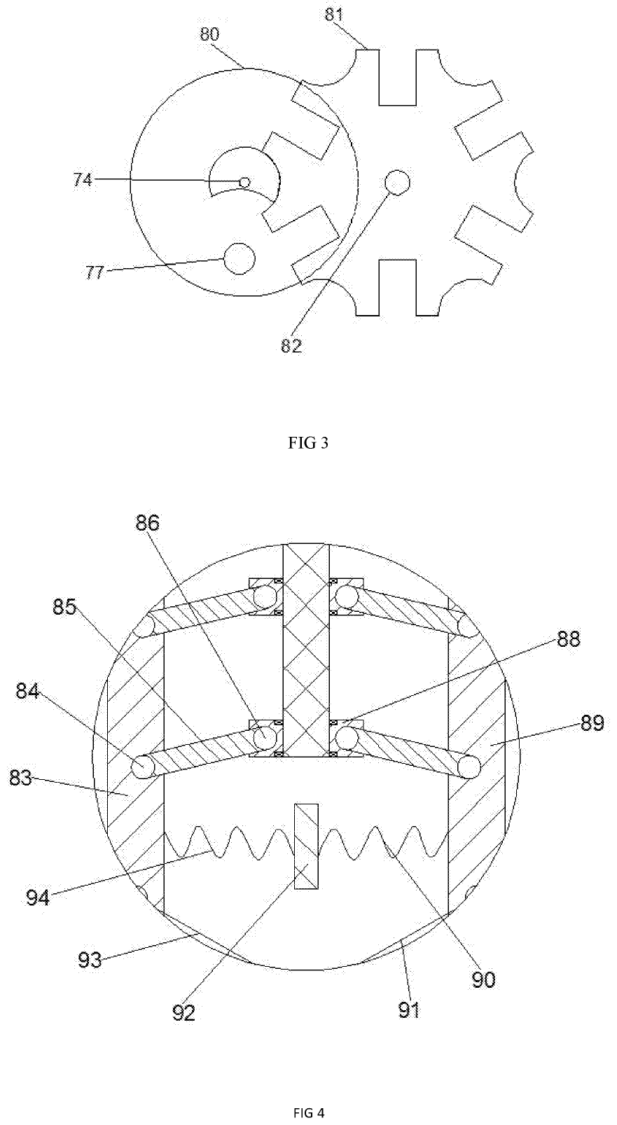

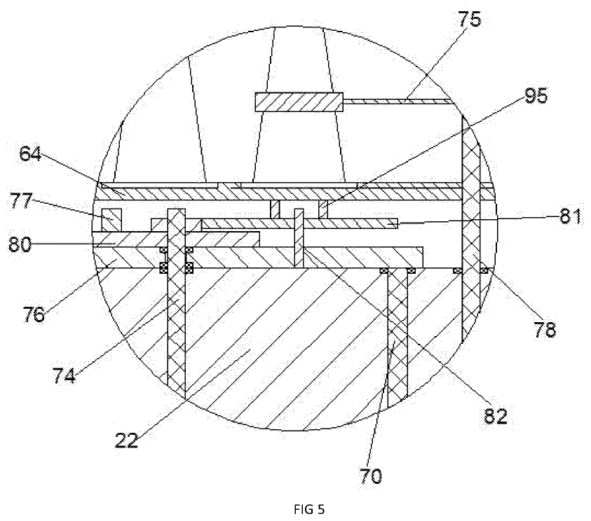

The present invention is described in detail below with reference to FIGS. 1-5. For convenience of description, the orientation described below is defined as follows: the up-down, left-right, front-back direction described below is consistent with the up-down, left-right, front-back direction of the projection relationship of FIG.

An automatic retracting and retracting device for a traffic cone of the device of the present invention includes a base body 22 and a fixed plate 76. The base body 22 is provided with a first movable cavity 20, and the first movable cavity 20 is provided with an intermittent pushing mechanism 21. A rotary cavity 35 is provided above the first movable cavity 20, and a reciprocating rotation mechanism 26 is provided in the rotary cavity 35. A second movable cavity 36 with a rightward opening is provided above the rotary cavity 35, and the second movable cavity A retracting mechanism 87 is provided in 36. A first rectangular groove 27 is provided on the left side of the rotation cavity 35. A second rectangular groove 62 is provided below the first rectangular groove 27. The second rectangular groove 62 is provided in A transmission mechanism 96, a first rotating shaft 24 is rotatably installed between a lower end wall of the first rectangular groove 27 and an upper end wall of the second rectangular groove 62, and an upper end of the first rotating shaft 24 projects into the first rectangular groove 27 A first bevel gear 28 is fixedly installed in the middle, and a lower end of the first rotating shaft 24 is inserted into the second rectangular groove 62 and a second bevel gear 11 is fixedly installed. A first bevel gear is provided above the second rectangular groove 62. Three rectangular grooves 60, a driving mechanism 97 is provided in the third rectangular groove 60, and a fourth A fifth rectangular groove 45 is provided on the right side of the fourth rectangular groove 47, and a right side wall of the second rectangular groove 62 and a left end wall of the fifth rectangular groove 45 are rotatably provided through the fourth groove. A second rotating shaft 54 of the rectangular groove 47, the right end of the second rotating shaft 54 projects into the fifth rectangular groove 45 and a third bevel gear 44 is fixedly installed, and the fourth rectangular groove 47 is provided with the A fourth bevel gear 48 fixedly connected to the second rotating shaft 54, an intermittent rotation mechanism 98 is provided above the fixed plate 76, and a feeding mechanism 99 is provided at an upper end wall of the base body 22.

Beneficially, the intermittent pushing mechanism 21 includes a third rotating shaft 25 and a fourth rotating shaft 23 installed in the rear wall of the first movable cavity 20 symmetrically, and the front end of the third rotating shaft 25 extends to the first rotating shaft 25. A first rotating plate 89 is rotatably installed in a movable cavity 20, a second fixed shaft 79 is fixedly installed in the second rotating plate 89, and a front end of the fourth rotating shaft 23 extends into the first movable cavity 20. A second rotating plate 83 is rotatably installed, a first fixing shaft 19 is fixedly installed in the second rotating plate 83, and a third fixing shaft 84 is fixedly installed vertically on the second rotating plate 83. A through hole is provided between the lower end wall of the movable cavity 36 and the upper end wall of the first movable cavity 20. A fifth rotation shaft 37 is installed in the through hole, and the lower end of the fifth rotation shaft 37 extends into the first movement cavity. A pusher block 88 is fixedly installed in 20, and a fourth fixed shaft 86 is fixedly installed symmetrically in the pusher block 88. The fourth fixed shaft 86 is rotatably mounted with a third fixed shaft 84. A first connecting rod 85, a baffle 92 is fixedly installed in the front and rear walls of the first movable cavity 20, and the baffle 92 and the first A first spring 90 is fixedly connected between the plates 89, and a second spring 94 is fixedly connected between the baffle 92 and the second rotating plate 83. The rear wall of the first movable cavity 20 is rotatably mounted symmetrically on the left and right sides. A sixth rotating shaft 16 and a seventh rotating shaft 12 are provided. A front end of the sixth rotating shaft 16 extends into the first movable cavity 20 and a fifth bevel gear 17 is fixedly installed on the sixth rotating shaft 16. A first cam 18 is fixedly installed in a movable cavity 20, and a fifth fixed shaft 15 is fixedly installed on the first cam 18. The fifth fixed shaft 15 and the second fixed shaft 79 are drawn through a first fixed distance. 91 is fixedly connected, the front end of the seventh rotating shaft 12 extends into the first movable cavity 20 and a sixth bevel gear 50 is fixedly installed, and the seventh rotating shaft 12 is fixedly installed in the first movable cavity 20 A second cam 49 is provided, and a sixth fixed shaft 13 is fixedly mounted on the second cam 49. The sixth fixed shaft 13 and the first fixed shaft 19 are fixedly connected through a second fixed-distance pull wire 93.

Advantageously, the reciprocating rotation mechanism 26 includes an eighth rotation shaft 30 rotatably installed between the right end wall of the first rectangular groove 27 and the left end wall of the rotation cavity 35, and the left end of the eighth rotation shaft 30 extends into the A seventh bevel gear 29 meshing with the first bevel gear 28 is fixedly installed in the first rectangular groove 27, and the right end of the eighth rotating shaft 30 extends into the rotation cavity 35 and a connecting plate 31 is fixedly installed. A second link 34 is fixedly installed in the connecting plate 31, and a driving plate 33 is movably mounted on the second link 34. A rack 32 is fixedly installed at the right end wall of the driving plate 33, and the fifth A first gear 38 meshing with the rack gear 32 is fixedly mounted on the rotating shaft 37 in the rotating cavity 35.

Beneficially, the retracting mechanism 87 includes a third link 39 fixedly mounted on the upper end of the fifth rotating shaft 37, and a right end of the third link 39 extends out of the base 22 and is fixedly mounted with an electromagnet 41.

Advantageously, the transmission mechanism 96 includes a ninth rotating shaft 57 rotatably installed between the lower end wall of the first movable cavity 20 and the upper end wall of the second rectangular groove 62, and the upper end of the ninth rotating shaft 57 extends into the An eighth bevel gear 14 meshing with the fifth bevel gear 17 is fixedly installed in the first movable cavity 20, and a lower end of the ninth rotating shaft 57 extends into the second rectangular groove 62 and a first Nine-bevel gear 58, the left end of the second rotating shaft 54 is dynamically connected to the motor 10 fixedly installed in the base 22, and is located in the second rectangular groove 62 and is fixedly connected to the second rotating shaft 54 and connected to The tenth bevel gear 61 meshed with the second bevel gear 11 is provided with an eleventh bevel gear 56 fixedly connected to the second rotating shaft 54 and meshing with the ninth bevel gear 58 in the second rectangular groove 62.

Beneficially, the driving mechanism 97 includes a tenth rotation shaft 52 rotatably installed between the lower end wall of the first movable cavity 20 and the upper end wall of the third rectangular groove 60, and the upper end of the tenth rotation shaft 52 extends into the A twelfth bevel gear 51 meshing with the sixth bevel gear 50 is fixedly installed in the first movable cavity 20, and a lower end of the tenth rotating shaft 52 extends into the third rectangular groove 60 and is fixedly installed. A second pulley 53, a first pulley 59 is fixedly mounted on the ninth rotating shaft 57 in the third rectangular groove 60, and the first pulley 59 and the second pulley 53 pass through a first belt 55 Power connection.

Advantageously, the intermittent rotation mechanism 98 includes a tenth rotation shaft 74 rotatably installed between the upper end wall of the fourth rectangular groove 47 and the upper end wall of the base body 22, and the lower end of the tenth rotation shaft 74 projects into the first rotation shaft 74. A twelfth bevel gear 46 meshing with the fourth bevel gear 48 is fixedly installed in the four rectangular grooves 47. An upper end of the tenth rotating shaft 74 extends out of the fixing plate 76 and a rotating wheel 80 is fixedly installed. A first fixing rod 77 is fixedly installed on the rotating wheel 80, and a seventh fixing shaft 82 is fixedly installed in the fixing plate 76. An upper end of the seventh fixing shaft 82 is rotatably installed in contact with the arc segment of the rotating wheel 80. A turntable 81 is provided with a fixed-slot groove. A second fixing rod 95 is fixedly mounted on the turntable 81. A bottom plate 64 is fixedly installed on the upper end of the second fixing rod 95. A positioning groove 63 is provided on the upper end surface of the bottom plate 64. A traffic cone 42 is positioned and installed on the bottom plate 64 through the positioning groove 63, and a small iron block 40 is fixedly installed on the upper end of the traffic cone 42.

Advantageously, the feeding mechanism 99 includes an eleventh rotation shaft 78 rotatably installed between the upper end wall of the fifth rectangular groove 45 and the upper end wall of the base body 22, and the lower end of the eleventh rotation shaft 78 extends into the A thirteenth bevel gear 43 meshing with the third bevel gear 44 is fixedly installed in the fifth rectangular groove 45, and an upper end of the eleventh rotating shaft 78 extends out of the base body 22 and a push rod 75 is fixedly installed. A third pulley 73 is fixedly mounted on the eleventh rotating shaft 78, and a guide plate 65 is fixedly installed at the outer end wall of the bottom plate 64. A roller 66 is fixedly installed in front of the guide plate 65, and the roller 66 is fixedly installed A conveyor belt 67 is installed, a thirteenth rotation shaft 68 is fixedly installed in the roller 66, a fourteenth bevel gear 69 is fixedly installed at the right end of the thirteenth rotation shaft 68, and a twelfth rotation shaft 70 is rotatably installed in the base 22. An upper end of the twelfth rotating shaft 70 extends out of the base body 22 and a fourth pulley 71 meshing with the fourteenth bevel gear 69 is fixedly installed. The fourth pulley 71 and the third pulley 73 is powered by a second belt 72.

In the initial state, the third link 39 is at the lower end position in the second movable cavity 36, the electromagnet 41 is not energized, and the first rotating plate 89 and the second rotating plate 83 are vertical. State, the first spring 90 and the second spring 94 are in an original length state, and the first fixed-distance pull wire 91 and the second fixed-distance pull wire 93 are in a relaxed state;

When starting to work, when the traffic cone needs to be placed outward, the worker first starts the motor 10 in the forward direction. The motor 10 can drive the eleventh bevel gear 56 to rotate through the second rotating shaft 54, and the tenth A bevel gear 56 can drive the ninth bevel gear 57 to rotate through the ninth bevel gear 58. On the one hand, the ninth bevel gear 57 can drive the fifth bevel gear 17 to rotate through the eighth bevel gear 14. The fifth bevel gear 17 can drive the first cam 18 to rotate through the sixth rotating shaft 16, and the first cam 18 can drive the first rotating plate 89 around the first cam 18 through the first fixed-distance pull line 91. The third rotating shaft 25 rotates to the left, the ninth rotating shaft 57 can also drive the first pulley 59 to rotate, and the first pulley 59 can drive the second pulley through the first belt 55 53 turns, the second pulley 53 can drive the twelfth bevel gear 51 through the tenth rotating shaft 52, and the twelfth bevel gear 51 can drive the first bevel through the sixth bevel gear 50 Seven rotation shafts 12 rotate, and the seventh rotation shaft 12 can drive the second cam 49 to rotate, and the second cam 49 can pass through the Two fixed-distance pull wires 93 drive the second rotating plate 83 to rotate to the right around the fourth rotating shaft 23. The second rotating plate 83 and the first rotating plate 89 can pass through the first link 85. Drive the push block 88 to move upward. The push block 88 can drive the third link 39 to move upward through the fifth rotating shaft 37. At this time, the electromagnet 41 is controlled to be energized, and the third link 39 The attraction force between the electromagnet 41 and the small iron block 40 can drive the traffic cone 42 to move upward, and the second rotating shaft 54 can drive the first rotating shaft 24 through the second bevel gear 11 Rotating, the first rotating shaft 24 can drive the seventh bevel gear 29 to rotate through the first bevel gear 28, and the seventh bevel gear 29 can drive the link plate 31 to rotate through the eighth rotating shaft 30. The connecting plate 31 can drive the driving plate 33 through the second link 34, and the driving plate 33 can drive the first gear 38 through the rack 32, and the first gear 38 can The fifth link shaft 37 drives the third link 39 to rotate, and the third link 39 can pass through the electromagnet 41 and the small iron block 40. The attractive force of the time drives the traffic cone 42 to rotate. When the traffic cone 42 rotates above the designated position, the electromagnet 41 is controlled to power off. The traffic cone 42 can fall to the designated position, thereby completing a traffic. After the placement of the cone, the rack 32 and the first gear 38 reversely mesh with each other. The first gear 38 can drive the third link 39 to reverse through the fifth rotation shaft 37. When the third link 39 is turned above a specified position, when the first cam 18 and the second cam 49 are turned to the other side, the second rotating plate 83 and the first A rotating plate 89 can be reset by the second spring 94 and the first spring 90, and the third link 39 moves downward, so that the next traffic cone can be placed, and the second The rotating shaft 54 can drive the twelfth bevel gear 46 to rotate through the fourth bevel gear 48, and the twelfth bevel gear 46 can drive the rotating wheel 80 to rotate through the tenth rotating shaft 74. 80 may drive the turntable 81 to rotate intermittently through the first fixing rod 77, and the turntable 81 may be rotated through the second fixing 95 drives the bottom plate 64 to rotate intermittently, the second rotating shaft 54 can drive the thirteenth bevel gear 43 to rotate through the third bevel gear 44, and the thirteenth bevel gear 43 can pass through the eleventh The rotating shaft 78 drives the push rod 75 to rotate, the eleventh rotating shaft 78 can drive the fourth pulley 71 to rotate through the second belt 72, and the fourth pulley 71 can pass through the fourteenth cone The gear 69 drives the thirteenth rotation shaft 68 to rotate, and the thirteenth rotation shaft 68 can drive the conveyor belt 67 to rotate through the roller 66, so that the required traffic cone can be continuously supplemented to the bottom plate 64 In the positioning groove 63.

When the traffic cone needs to be recovered, the worker first starts the motor 10 in the reverse direction, and then controls the on/off of the electromagnet 41 as opposed to when it is placed outward, and other working principles are the same as when it is placed outward.

The beneficial effect is that: when using, controlling the on/off of the electromagnet to generate magnetic presence to realize the placement and recovery of the traffic cone, the placement and recovery process is relatively stable, and accurate positioning can be guaranteed, thereby The accuracy of retracting and retracting the traffic cone is improved.

When in use, the motor can drive the push rod to rotate through the eleventh rotating shaft, and the push rod can push the traffic cone into the positioning groove, thereby intermittently supplementing the traffic cone, which can meet the needs The requirements for placing different quantities expand the range of use of the device.

The above are only specific embodiments of the invention, but the scope of protection of the invention is not limited to this. Any changes or replacements that are not thought through without creative work should be covered by the scope of protection of the invention. Therefore, the protection scope of the invention shall be subject to the protection scope defined by the claims.

1. An automatic retracting and retracting device for a traffic cone includes a base body and a fixed plate. The base body is provided with a first movable cavity, the first movable cavity is provided with an intermittent pushing mechanism, and a rotating cavity is provided above the first movable cavity. The revolving cavity is provided with a reciprocating rotation mechanism, a second movable cavity opening to the right is provided above the rotating cavity, a retracting mechanism is provided in the second movable cavity, and a first movable cavity is provided on the left side of the rotating cavity. A rectangular slot, a second rectangular slot is provided below the first rectangular slot, a transmission mechanism is arranged in the second rectangular slot, and a rotation between a lower end wall of the first rectangular slot and an upper end wall of the second rectangular slot A first rotating shaft is installed, an upper end of the first rotating shaft extends into the first rectangular groove and a first bevel gear is fixedly installed, and a lower end of the first rotating shaft extends into the second rectangular groove and is fixedly installed There is a second bevel gear, a third rectangular slot is provided above the second rectangular slot, a driving mechanism is provided in the third rectangular slot, a fourth rectangular slot is provided on the right side of the second rectangular slot, and the first A fifth rectangular slot is provided on the right side of the four rectangular slots, and the second rectangular slot is right A second rotating shaft penetrating through the fourth rectangular groove is provided between the wall and the left end wall of the fifth rectangular groove. The right end of the second rotating shaft extends into the fifth rectangular groove and a third cone is fixedly installed. For the gear, a fourth bevel gear fixedly connected to the second rotating shaft is provided in the fourth rectangular groove, an intermittent rotation mechanism is arranged above the fixed plate, and a feeding mechanism is arranged at the upper end wall of the base body.

2. The automatic retracting and retracting device for a traffic cone according to claim 1, wherein the intermittent ejection mechanism comprises a third rotating shaft and a fourth rotating shaft which are installed in the rear wall of the first movable cavity symmetrically to rotate left and right. A rotating shaft, a front end of the third rotating shaft extends into the first movable cavity and a first rotating plate is rotatably installed, a second fixed shaft is fixedly installed in the second rotating plate, and a front end of the fourth rotating shaft extends into A second rotating plate is rotatably installed in the first movable cavity, a first fixed shaft is fixedly installed in the second rotating plate, and a third fixed shaft is fixed and installed symmetrically on the second rotating plate; A through hole is provided between the lower end wall of the second movable cavity and the upper end wall of the first movable cavity. A fifth rotating shaft is installed in the through hole, and the lower end of the fifth rotating shaft projects into the first movable cavity. A push block is fixedly installed, and a fourth fixed shaft is fixedly mounted on the left and right sides symmetrically, and a first link fixedly connected to the third fixed shaft is rotatably mounted on the fourth fixed shaft. Baffles are fixedly installed in the front and rear walls of the first movable cavity. A first spring is fixedly connected between the first rotating plate, a second spring is fixedly connected between the baffle and the second rotating plate, and a first spring is installed in the rear wall of the first movable cavity symmetrically to rotate left and right. Six rotation shafts and a seventh rotation shaft, a front end of the sixth rotation shaft extends into the first movable cavity and a fifth bevel gear is fixedly installed, and the sixth rotation shaft is fixedly installed in the first movable cavity. A cam, a fifth fixed shaft is fixedly mounted on the first cam, the fifth fixed shaft and the second fixed shaft are fixedly connected by a first fixed-distance pull line, and the front end of the seventh rotating shaft projects into the A sixth bevel gear is fixedly installed in the first movable cavity, a second cam is fixedly installed in the first movable cavity on the seventh rotating shaft, and a sixth fixed shaft is fixedly installed on the second cam. The sixth fixed shaft and the first fixed shaft are fixedly connected by a second fixed-distance pull wire.

3. The automatic retracting and retracting device for a traffic cone according to claim 2, wherein the reciprocating rotation mechanism includes a first rotation revolving mechanism installed between a right end wall of the first rectangular groove and a left end wall of the rotating cavity.

4. Eight rotating shafts, the left end of the eighth rotating shaft extends into the first rectangular groove and a seventh bevel gear meshing with the first bevel gear is fixedly installed, and the right end of the eighth rotating shaft extends into the rotating cavity A connecting plate is fixedly installed in the middle and the second plate is fixedly installed in the connecting plate, a driving plate is movably installed on the second connecting rod, and a rack is fixedly installed at the right end wall of the driving plate. A first gear that meshes with the rack is fixedly mounted on the fifth rotating shaft in the rotating cavity.
The automatic retracting and retracting device for a traffic cone according to claim 3, wherein the retracting mechanism comprises a third link fixedly mounted on the upper end of the fifth rotation shaft, and a right end of the third link The base body is extended and fixed with an electromagnet.

5. The automatic retracting and retracting device for a traffic cone according to claim 4, wherein the transmission mechanism comprises a rotating installation between a lower end wall of the first movable cavity and an upper end wall of the second rectangular groove.

6. A ninth rotating shaft, an upper end of the ninth rotating shaft is extended into the first movable cavity and an eighth bevel gear meshing with the fifth bevel gear is fixedly installed, and a lower end of the ninth rotating shaft is extended into the first A ninth bevel gear is fixedly installed in the two rectangular grooves, and the left end of the second rotating shaft is dynamically connected to a motor fixedly installed in the base body. A fixed connection to the second rotating shaft is provided in the second rectangular groove. The tenth bevel gear meshing with the second bevel gear is provided with an eleventh bevel gear fixedly connected to the second rotating shaft and meshing with the ninth bevel gear in the second rectangular groove.

6. The automatic retracting and retracting device for a traffic cone according to claim 5, wherein the driving mechanism comprises a rotation mounted between a lower end wall of the first movable cavity and an upper end wall of the third rectangular groove.

7. A tenth rotating shaft, an upper end of the tenth rotating shaft is extended into the first movable cavity and a twelfth bevel gear meshing with the sixth bevel gear is fixedly installed, and a lower end of the tenth rotating shaft is extended into the A second pulley is fixedly installed in the third rectangular groove, and a first pulley is fixedly installed in the third rectangular groove on the ninth rotating shaft, and the first pulley passes through the second pulley The first belt is powered.
The automatic traffic cone retracting and retracting device according to claim 6, characterized in that the intermittent rotation mechanism comprises a tenth rotation installation between the upper end wall of the fourth rectangular groove and the upper end wall of the base body. A rotating shaft, the lower end of the tenth rotating shaft is inserted into the fourth rectangular groove and a twelfth bevel gear meshing with the fourth bevel gear is fixedly installed; the upper end of the tenth rotating shaft extends out of the fixing plate and A runner is fixedly installed, a first fixing rod is fixedly installed on the runner, a seventh fixed shaft is fixedly installed in the fixed plate, and an upper end of the seventh fixed shaft is rotatably installed with a circular arc segment with the runner A turntable that is in contact with a fixed distance slot, a second fixing rod is fixedly mounted on the turntable, a bottom plate is fixedly mounted on the upper end of the second fixing rod, and a positioning groove is provided on the upper end surface of the bottom plate, A traffic cone is positioned and installed on the positioning groove, and a small iron block is fixedly installed on the upper end of the traffic cone.

8. The automatic retracting and retracting device for a traffic cone according to claim 7, wherein the feeding mechanism comprises a tenth part that is rotatably installed between the upper end wall of the fifth rectangular groove and the upper end wall of the base body. A rotating shaft, the lower end of the eleventh rotating shaft is inserted into the fifth rectangular groove and a thirteenth bevel gear meshing with the third bevel gear is fixedly installed, and the upper end of the eleventh rotating shaft extends out of the The base body is fixedly installed with a push rod, a third pulley is fixedly installed on the eleventh rotating shaft, a guide plate is fixedly installed at the outer end wall of the bottom plate, and a roller is fixedly installed in front of the guide plate. A conveyor belt is fixedly installed, a thirteenth rotating shaft is fixedly installed in the roller, a fourteenth bevel gear is fixedly installed at the right end of the thirteenth rotating shaft, a twelfth rotating shaft is rotationally installed in the base body, and the twelfth An upper end of the rotating shaft protrudes from the base body, and a fourth pulley meshing with the fourteenth bevel gear is fixedly installed, and the fourth pulley and the third pulley are dynamically connected through a second belt.
